(19) United States
(12) Patent Application Publication
(10) Pub. No.: US 2010/0230088 A1
(43) Pub. Date: Sep. 16, 2010

(54) STORAGE COMBINATION BOILER

(75) Inventors: David Clark, Peterborough (GB); David Steade, Peterborough (GB)

Correspondence Address: Ballard Spahr LLP, SUITE 1000, 999 PEACHTREE STREET, ATLANTA, GA, 30309-3915, US

(73) Assignee: MICROGEN ENGINE CORPORATION HOLDING B.V., Reading (NL)

(21) Appl. No.: 12/448,448

(22) PCT Filed: Dec. 19, 2007
(86) PCT No.: PCT/GB2007/004871

§ 371 Date: May 21, 2010

(30) Foreign Application Priority Data
Dec. 20, 2006 (GB) 0625485.8

(51) Int. Cl. G05D 23/00; F24H 9/20

(52) U.S. Cl. 165/287; 122/14.22

(57) ABSTRACT

A storage combination boiler system and a method for providing heating, comprising: a domestic combined heat and power (dchp) unit, which provides a heat output and an electricity output; a first piping system, containing fluid which is heated by the heat output of the dchp unit; a second piping system, containing fluid which is heated by transfer of heat from the fluid in the first piping system using a heat exchanger; and a storage vessel, located within the first piping system, downstream from the heat exchanger, for receiving and storing fluid within that first piping system so as to provide a thermal store for the heat in the first piping system.

### TECHNICAL FIELD

This invention relates to a storage combination boiler using a domestic combined heat and power (dchp) unit to provide heating and hot water supply to meet user requirements, without the need for an external tank to store hot water.

### BACKGROUND TO THE INVENTION

An advantage of dchp units is their ability to provide heating, hot water and electrical power to a household with a single engine, thereby giving a high overall efficiency. For example, our International Patent Application, WO-A-03/084023, describes such a dchp unit that comprises a Stirling engine generator.

The electricity output can be used either when the household demands electricity or it may be sold back into the electrical grid supplying the household. Hence, the net amount of electricity drawn from the grid can be reduced. The electrical power output of a dchp unit will depend on the generating capacity of its engine, which will be fixed for a specific unit, and the length of time for which it is operated, which may be controlled. Maximising engine run-time is therefore advantageous.

Such dchp units can form part of a boiler to provide central heating and hot water. Typically, the dchp unit will then be controlled based on the heating and hot water requirements of the household. At the most basic level, this means that the dchp unit will be operated when there is a heat demand and turned off when the demand is satisfied. Such a strategy will result in on/off cycling of the dchp unit engine and any supplementary systems, which reduces the longevity of these components.

Moreover, these boilers are unable to provide heating with instantaneous hot water, without the use of a supplementary hot water tank. In addition to being an inefficient means of producing and storing hot water, this creates possible problems of flooding due to freezing and of increased piping. Storage combination boilers with conventional burners, for example as described in GB 2 301 423, transfer heat from the heating circuit to the hot water circuit, thereby allowing provision of hot water as required. The water is heated directly from the water mains and is therefore supplied at mains pressure, without the need for a pump. The burner can be turned on and off as needed, to meet both the heating and hot water demand, without reducing the burner's longevity.

GB-A-2 410 790 describes a micro combined heat and power engine, which heats water that is then stored in a thermal storage apparatus. Water is pumped out of the thermal storage apparatus and through a plate heat exchanger that transfers heat to a hot water system. The thermal storage apparatus has two temperature sensors, on which basis the combined heat and power engine is controlled. This prevents cycling of the combined heat and power engine. However, the thermal storage apparatus is intended to store and therefore provide supplementary heat when the combined heat and power engine is not able to provide sufficient heat to meet demand, for instance before the engine is fully warmed up. This reduces the total length of time that the combined heat and power engine needs to run in a day.

Our International Patent Application No. PCT/GB04/004835 describes an alternative strategy for controlling the dchp unit to reduce this cycling, using temperature measurements, predictions and preheat periods. However, this is intended to maximise engine run-time, at the expense of supplementary systems. This improves the electricity generation efficiency.

A storage combination boiler using a dchp unit is an advantageous development. However, predictive algorithms, intended to reduce cycling of the dchp unit and maximise engine run-time, are not readily suitable for provision of instantaneous hot water.

### SUMMARY OF THE INVENTION

Against this background, and in a first aspect, the present invention provides a storage combination (combi) boiler system, comprising: a domestic combined heat and power (dchp) unit, which provides a heat output and an electricity output; a first piping system, containing fluid which is heated by the heat output of the dchp unit, or a supplementary boiler in series with the dchp unit; a second piping system, containing fluid which is heated by transfer of heat from the fluid in the first piping system using a heat exchanger; and a storage vessel, located within the first piping system, downstream from the heat exchanger, for receiving and storing fluid within that first piping system so as to provide a thermal store for the heat in the first piping system.

The storage vessel acts as a thermal flywheel—allowing nearly continuous (smooth) operation of the generator, during peaky (thermal) loads: by increasing the volume of water in the first piping system, its thermal capacity is increased, slowing down the rate of change of temperature of the piping system. Placing the storage vessel downstream from the heat exchanger thus avoids the need for the dchp unit to be switched off as soon as any demand for hot water is removed, for instance when a tap in the household is turned off, since the heat in the storage vessel will have been significantly depleted through the hot water demand. This means that the time over which the dchp unit is operated may be maximised. Advantageously, these features also prevent cycling in operation of the dchp unit and allow maximum electricity generation ability. This prolongs the lifetime of the dchp unit, whilst maximising heat and power generation efficiency.

The storage vessel thereby slows down the rate at which the fluid stored therein heats and cools, thereby acting as a thermal flywheel. Hence, the storage vessel increases the time taken for the fluid stored therein to reach a specified temperature. The storage vessel also prevents the combined heat and power unit from being switched off as soon as any demand for hot water is met, for instance when a tap in the household is turned off. This means that the time over which the dchp unit is operated is maximised.

Preferably, the storage vessel is physically separate from the heat exchanger. By physically separating the storage vessel from the heat exchanger for the second piping system (domestic hot water), a principle benefit of a combi system—that of instantaneous hot water, irrespective of previous usage—is retained (unlike conventional “non-combi” systems, in which the hot water heat exchanger resides in the storage vessel).

In the preferred embodiment, the heating system also comprises a controller, configured to control the dchp unit based on a temperature at the storage vessel. Advantageously, the controller is arranged to control the dchp unit based upon a comparison of the temperature of the storage vessel with a threshold temperature. For example, when the temperature of the storage vessel falls below the threshold temperature, the dchp unit may be controlled to increase the heat provided to the first fluid. The threshold temperature may be the specified temperature for the storage vessel. The specified temperature may be provided as an input to the system by the user, or it may be predetermined.

Preferably, the controller is arranged to control the dchp unit based upon a rate of change of the temperature of the storage vessel. Optionally, the controller is arranged to control the dchp unit based on a comparison of rate of change of the temperature of the storage vessel with a threshold rate of change of temperature. For example, when the temperature decreases at a rate greater than the threshold, the dchp unit may be controlled to increase the heat provided to the first fluid, so that the heat provided to the second fluid is also increased. Advantageously, control using the temperature may be combined with control using the rate of change of temperature to control both the central, heating and the hot water at the same time.

The storage vessel preferably causes the fluid stored within the storage vessel to have a rate of change of temperature substantially less than the rate of change of temperature of the fluid in the first piping system without the storage vessel. The storage vessel may be of a sufficient volume so as to cause this to be the case. Optionally, the volume of the storage vessel is 100 litres. The use of a storage vessel may decrease the rate of change of temperature by at least 10%, preferably 50% and optionally approximately 100%.

The first piping system preferably comprises a piping circuit. Advantageously, the first piping system also comprises: a second piping circuit; and a valve, configured to cause the first fluid either to flow around the first piping circuit or to flow around the second piping circuit. This allows the provision of hot water on demand without central heating. In the preferred embodiment, the storage vessel is located in the first piping circuit. In the preferred embodiment, the second piping circuit is a central heating piping network and the fluid in the first piping system is a central heating fluid. By so doing, the dchp unit can be advantageously controlled without any effect from the central heating system.

Preferably, the dchp unit comprises a Stirling engine generator. Optionally, the dchp unit further comprises a secondary burner, adapted to heat the first fluid. The controller is beneficially arranged to switch on the secondary burner when the rate of change of temperature is greater than a rate of change of temperature threshold and the temperature is less than a threshold.

Optionally, the storage vessel comprises a first tank and a second tank. Advantageously, a boiler housing is provided, which is arranged to enclose the dchp unit. The boiler housing is advantageously further arranged to enclose at least a part of the storage vessel, and preferably the boiler housing is arranged to fully enclose the storage vessel.

In a second aspect, the present invention includes a method for providing heating, using a domestic combined heat and power (dchp) unit that provides a heat output and an electricity output, the method comprising: heating a fluid in a first piping system, with the heat output of the dchp unit; heating a fluid in a second piping system, by transfer of heat from the fluid in the first piping system; and receiving and storing fluid within the first piping system in a storage vessel located within that first piping system so as to provide a thermal store for the heat in the first piping system. Optionally, the step of receiving and storing causes the fluid stored within the storage vessel to have a rate of change of temperature, substantially less than the rate of change of temperature of the fluid in the first piping system outside of the storage vessel.

In the preferred embodiment, the step of receiving and storing occurs after the step of heating the second fluid.

The method preferably further comprises controlling the dchp unit based on a temperature at the storage vessel. This may be based upon a comparison of the temperature of the storage vessel with a threshold temperature. Beneficially, this may be based upon a rate of change of the temperature of the storage vessel. Optionally, this is based on a comparison of rate of change of the temperature of the storage vessel with a threshold rate of change of temperature.

### BRIEF DESCRIPTION OF THE DRAWINGS

The invention may be put into practice in various ways, one of which will now be described by way of example only and with reference to the accompanying drawings in which:

FIG. 1 shows a schematic block diagram of a heating system according to the present invention.

FIG. 2 shows a schematic diagram of a storage combination boiler arrangement in accordance with FIG. 1.

FIG. 3 shows a graph of storage vessel temperature against time for a heating system operating in line with FIG. 1.

FIG. 4 shows an operating flow chart for the storage combination boiler of FIG. 2.

### SPECIFIC DESCRIPTION OF A PREFERRED EMBODIMENT

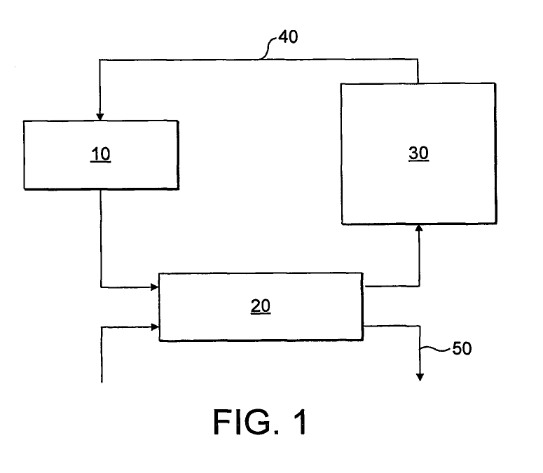

Referring first to FIG. 1, there is shown a schematic block diagram of a storage combination boiler according to the present invention. The storage combination boiler comprises an engine 10, a heat exchanger 20, and a storage vessel 30.

The engine 10 is arranged to provide a heat output, and is also used to generate an electricity output. Water, travelling through a first circuit 40, is heated by the engine 10, the heated water then flows through a heat exchanger 20. A second water supply 50 also passes through the heat exchanger 20, which causes the second water supply 50 to be heated by the water flowing through the first circuit. The water flowing out of the heat exchanger 20 on the first circuit then flows into a storage vessel 30. The storage vessel 30 is of sufficient volume such that water flowing through the storage vessel 30 remains within the storage vessel for a significant period of time before flowing out of the storage vessel 30 and flowing back towards the engine 10.

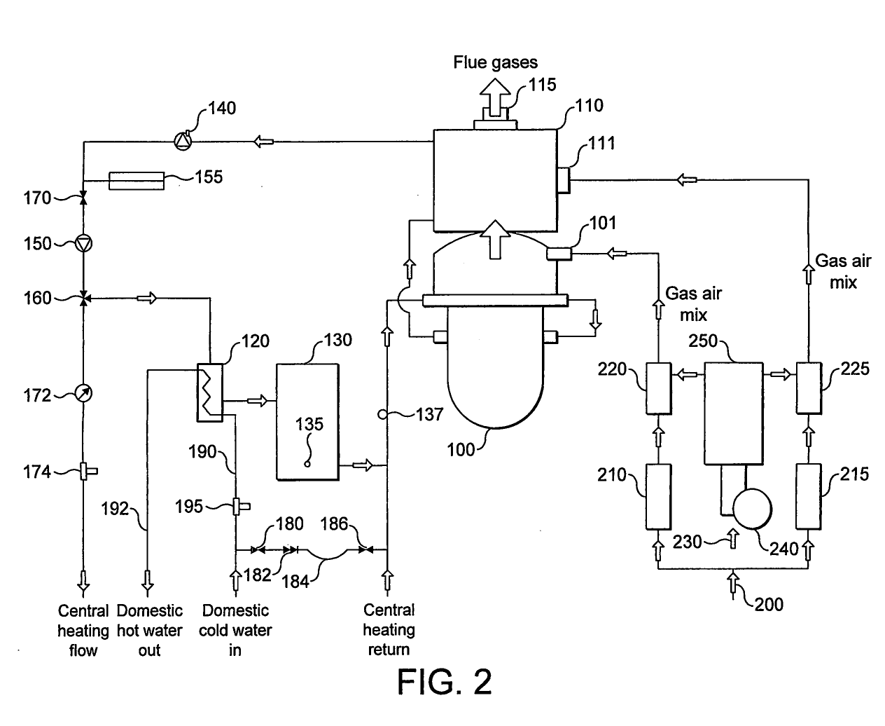

Turning to FIG. 2, there is shown a schematic diagram of an embodiment of a storage combination boiler arrangement. The storage combination boiler is contained within a single housing, with inlets and outlets as indicated. The storage combination boiler comprises Stirling engine 100, first heat exchanger 110, second heat exchanger 120 and primary storage vessel 130. The diagram shows a sealed water system where the engine 100 is adapted to operate at a maximum cooling fluid pressure of approximately 3 bar.

Cold water begins a circuit by flowing through Stirling engine 100 where it is first heated. This cold water is the central heating fluid. It then flows through first heat exchanger 110, where it is further heated by the exhaust gases from the Stirling engine burner 101, and optionally by heat from a secondary burner 111. The heated fluid can then flow to second heat exchanger 120, where it is used to heat a second water supply, which flows in through conduit 190 and out of heat exchanger 120 through conduit 192. This second water supply, which does not form part of the central heating circuit, is used to provide domestic hot water, such that conduit 190 supplies fresh, clean water and conduit 192 provides clean hot water. When a demand for hot water is sensed, for example when a hot water tap is turned on, sanitary flow switch 195 is triggered.

The central heating fluid flows out of second heat exchanger 120 and into storage vessel 130, which is a 100 litre insulated tank and is located within the boiler housing. The storage vessel has a temperature sensor 135. The central heating fluid then flows out of storage vessel 130, and then flows back towards the Stirling engine 100 to start the circuit again.

Flue 115 is provided to allow the flue gases emerging from the burner 101 of Stirling engine 100 and supplementary burner 111 of first heat exchanger 110 to be exhausted.

The central heating fluid leaving the supplementary heat exchanger 110 passes through an automatic air vent 140. A connection is then made to an expansion tank 155, and a pressure relief valve 170. Expansion tank 155 is provided to accommodate the expansion of the fluid in the central heating piping circuit as the operating temperature increases.

Primary pump 150 is provided to pump the central heating fluid. The central heating fluid then flows to a three way valve 160. The three-way valve 160 is a three port two position water diverting valve. Three-way valve 160 can be configured to send the pumped heating fluid either to second heat exchanger 120, as described above, or around the domestic heating circuit. Pressure gauge 172 and drain off valve 174 are also provided.

This fluid then flows through the main central heating circuit to join with the flow from out of the storage vessel 130, which flows back towards Stirling engine 100, past flow thermistor 137.

When the sanitary flow switch 195 is triggered, it causes primary pump 150 to be activated and for three-way valve 160 to be set to cause the central heating fluid to flow towards the second heat exchanger 120.

A filling loop is also provided, which allows water to flow from the domestic water supply into the central heating fluid through stop valve 180, double check valve 182, temporary hose 184 and stop valve 186.

A fuel input is also provided to Stirling engine 100 for main burner 101 and supplementary heat exchanger 110 for supplementary burner 111. Gas is provided at input 200 and is split between gas valve 210 and gas valve 215. The gas emerging through each gas valve flows to venturi 220 and venturi 225 respectively. Air is also provided through input 230 and fan 240. The air flows to splitter box 250, which provides air to venturi 220 and venturi 225. The two mixtures of gas and air are provided to Stirling engine burner 101 and the burner within the first heat exchanger 111 respectively.

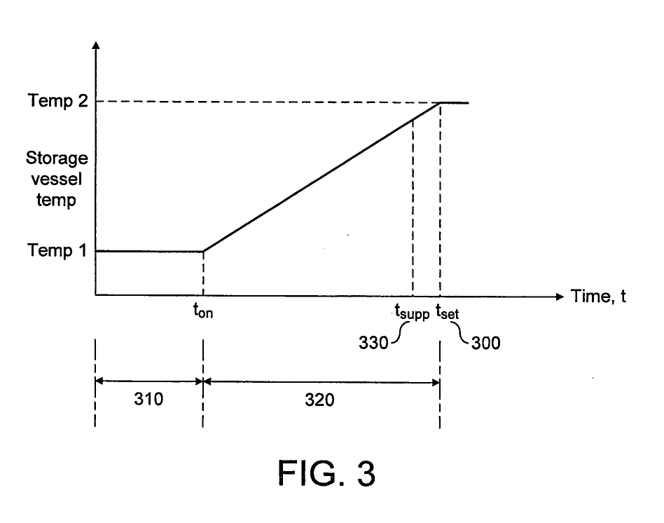

Referring to FIG. 3, there is shown a graph of storage vessel temperature against time when the dchp unit within a heating system according to the present invention is turned on. The user of the heating system provides a time 300 when hot water of a required temperature is desired (tₛₑₜ). In time period 310, the dchp unit is switched off. There will be some delay between the time at which the dchp unit is switched on (tₒₙ) and the time at which the required hot water may be provided. The heating system is controlled such that this delay, time period 320, is calculated. The controller will make maximum use of the engine within the dchp unit to achieve this temperature and will therefore switch on the dchp unit at time period 320 before the time 300 that the hot water is required.

The time period 320 (tₛₑₜ−tₒₙ) is calculated on the basis of a rate of rise of the storage vessel temperature and the difference in temperature between the temperature of the storage vessel and that required by the user for the hot water. Characteristics of the storage vessel, for example its volume and insulation will affect the rate of rise of the storage vessel temperature. In general, the larger the volume of the storage vessel, the smaller the rate of rise of its temperature and hence, the longer time period 320 will need to be.

The rate of rise of the storage vessel temperature is determined using a rolling average over the previous ten starts. For the dchp unit of FIG. 2, which uses a Stirling engine generator, this measurement will start once the engine head temperature reaches 550° C. and will end either when the required temperature for the storage vessel has been reached, or the temperature of the storage vessel has stopped increasing due to the heat output limitations of the dchp unit.

The difference in temperature is determined by measuring the storage vessel temperature a set time before the time 300 that the hot water is required and subtracting this from the required hot water temperature. A predetermined limit is set on the maximum time period 320.

When the dchp unit is turned on at time period 320 before required time 300, initially only the Stirling engine is activated. The rate of change of storage vessel temperature is continuously calculated. If after a specified time 330, the rate of change of storage vessel temperature is insufficient to ensure that the storage vessel temperature will meet the required value at required time 300, the supplementary burner in the dchp unit is also activated.

The control logic, which controls this operation also assumes that maximum engine run time is required at the expense of increased hot water temperature recovery times, a fixed speed central heating pump is used, the minimum storage vessel temperature to achieve hot water required temperature is 65° C., and that the 100 litre storage vessel will provide CW4 (European/Dutch combi hot water requirement) performance at 65° C. start temperature.

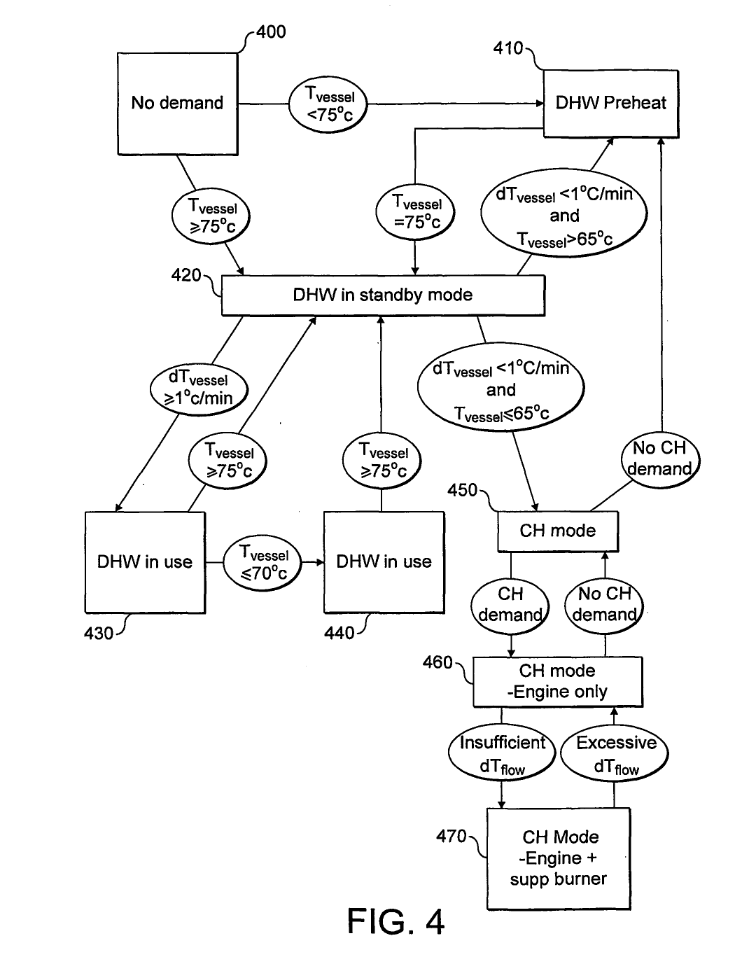

Referring to FIG. 4, there is shown a flowchart for operation of the storage combination boiler of FIG. 1 or FIG. 2. Initial state 400 is when there is no demand in the household for either central heating or hot water. The user provides a time when hot water is required (tₒₙ) and a specified temperature for the hot water, for example 75° C. will be used with reference to FIG. 4. The procedure for heating the fluid in the storage vessel 130 is determined in accordance with that outlined with respect to FIG. 3 above. If the temperature of the storage vessel 130 is greater than or equal to 75° C. then the system moves to state 420. Otherwise, the time period 320 required to reach the specified temperature is calculated and the dchp unit is switched on at the time predicted to meet the household's requirements and the system moves to state 410.

In state 410, the dchp unit is operated such that the engine 100 heats the central heating fluid. Pump 150 is also operated and valve 160 is set to supply the second heat exchanger 120. When the storage vessel 130 reaches 75° C., the system moves to state 420.

In state 420, the temperature of the storage vessel 130 is monitored. The rate of change of temperature in the storage vessel 130 is also determined. If the rate of fall of temperature is less than 1° C./min and the temperature of the storage vessel 130 is less than or equal to 65° C., the system returns to state 410, as described above. If the rate of change of temperature is less than 1° C./min and the temperature of the storage vessel 130 is greater than 65° C., the system moves to state 450, as will be described below. Otherwise, if the rate of fall of temperature is greater than or equal to 1° C., the system moves to state 430.

In state 430, the hot water supply is being operated such that the temperature of storage vessel is rapidly decreasing. The main burner 101 of engine 100 heats the central heating fluid and, as described above, the pump 150 is operated and valve 160 is set to allow the fluid to flow into second heat exchanger 120. The temperature of the storage vessel 130 is monitored. If there is no demand for hot water determined by the sanitary water flow switch 195, the system returns to state 420. In this case, the temperature of the storage vessel 130 is greater than or equal to 75° C. If no hot water demand is indicated by the state of sanitary flow switch 195 then the system moves to state 410 (this transition is not marked on FIG. 4). If the temperature of the storage vessel 130 is less than or equal to 70° C., the system moves to state 440.

In state 440, the hot water is being used, but the engine alone is unable to satisfy the demand for hot water. Then, the supplementary burner is activated. The temperature of the storage vessel 130 is monitored and if it is greater than or equal to 75° C. and the sanitary flow switch 195 is still triggered, the system returns to state 430 (this transition is also not shown on FIG. 4). If the sanitary flow switch 195 is reset, the system returns to state 420.

In state 450, the system determines if there is a demand for central heating. If there is no demand, the system returns to state 410, such that the temperature of the storage vessel 130 is increased. Otherwise, the system moves to state 460.

In state 460, the main burner 101 of engine 100 and pump 150 are operated. The valve 160 is set to allow water to flow around the central heating circuit. The average rate of increase of temperature for the heating circuit is monitored using flow thermistor 137. This sensor is monitored between the seventh and tenth minute after this state is effected. If the average rate of increase of temperature is greater than or equal to 1° C./min and there is still a central heating demand, the system continues in state 460. If there is still a central heating demand and the average rate of increase of temperature is less than 1° C./min, the system moves to state 470. If there is no central heating demand, the system moves back to state 450.

In state 470, the system operates as in state 460, except that the supplementary burner 111 is additionally operated. However, if the average rate of increase of temperature; measured by flow thermistor 137, is greater than or equal to 1° C./min, the system reverts to state 460.

Whilst a specific embodiment has been described herein, the skilled person may contemplate various modifications and substitutions. For example, the required temperature may be different than 75° C., depending on the household's requirements. Also, the rate of change of temperature threshold of 1° C./min and minimum temperature of 65° C. may be different.

Although the preferred embodiment of the present invention uses a single tank, housed within the boiler housing as a storage vessel, the skilled person will understand that alternatives are possible. The tank may be located'outside of the boiler housing. If so, it is desirable that the tank be located very close to the rest of the boiler, to avoid wasteful heat loss. Alternatively, the connections between the rest of the boiler and the tank should be adequately lagged or otherwise insulated.

More than one tank may be provided, either within or outside the boiler housing, with similar concerns in respect of heat loss. Then, the temperature at the storage vessel may be a function of the temperature at one of the tanks, or a function of the temperature at more than one of the tanks. Alternatively, the skilled person will appreciate that the storage vessel may comprise a pipe network. It is important however, that however the storage vessel is embodied, it is sufficient to act as a thermal store, such that its inclusion in the boiler reduces the rate of change of temperature in the central heating piping network below what it would be without the inclusion of a storage vessel.

Although the engine 100 is specified to operate at a cooling fluid pressure of 3 bar, the skilled person will realise that an open vented arrangement, with lower fluid pressures, could instead be utilised.

The skilled person will also understand that the invention is not limited to Stirling-Engine based dchp units. Similar difficulties (those relating to the requirement to avoid problematic rapid on-off cycling of the generator) are faced by other types of dchp unit, such as those incorporating internal combustion engines, fuel-cell systems etc. These difficulties are also apparent when such dchp units are implemented in combi systems. As well as the undesirability, from a demand and supply management aspect, of rapid-cycling on and off of the local generator, other dchp systems such as fuel cells also operate only when hot, and so frequently stopping, cooling, and restarting is deleterious.

1. A storage combination boiler system, comprising:
a domestic combined heat and power (dchp) unit, which provides a heat output and an electricity output;
a first piping system, containing fluid which is heated by the heat output of the dchp unit;
a second piping system, containing fluid which is heated by transfer of heat from the fluid in the first piping system using a heat exchanger; and
a storage vessel, located within the first piping system, downstream from the heat exchanger, for receiving and storing fluid within that first piping system so as to provide a thermal store for the heat in the first piping system.

2. The storage combination boiler system claim 1, wherein the first piping system comprises:
a first piping circuit;
a second piping circuit; and
a valve, configured to cause the fluid in the first piping system either to flow around the first piping circuit or to flow around the second piping circuit; and
wherein the storage vessel is located in the first piping circuit.

3. The storage combination boiler system of claim 2, wherein the second piping circuit is a central heating piping network and the fluid in the first piping system is a central heating fluid.

4. The storage combination boiler system of claim 1, further comprising: a controller, configured to control the dchp unit based on a temperature at the storage vessel.

5. The storage combination boiler system of claim 4, wherein the controller is arranged to control the dchp unit based upon a comparison of the temperature of the storage vessel with a threshold temperature.

6. The storage combination boiler system of claim 4, wherein the controller is arranged to control the dchp unit based upon a rate of change of the temperature of the storage vessel.

7. The storage combination boiler system of claim 6, wherein the controller is arranged to control the dchp unit based on a comparison of rate of change of the temperature of the storage vessel with a threshold rate of change of temperature.

8. The storage combination boiler system of claim 1, wherein the storage vessel is of sufficient volume so as to cause the fluid stored therein to have a rate of change of temperature substantially less than the rate of change of temperature of the fluid in the first piping system without the storage vessel.

9. The storage combination boiler system of claim 1, wherein the dchp unit comprises a Stirling engine.

10. The storage combination boiler system of claim 9, wherein the dchp unit further comprises a secondary burner and a heat exchanger, adapted to heat the fluid in the first piping system.

11. The storage combination boiler system of claim 7, wherein the dchp unit further comprises a secondary burner and a heat exchanger, adapted to heat the fluid in the first piping system, wherein the controller is arranged to switch on the secondary burner when the rate of change of temperature of the storage vessel is greater than a rate of change of temperature threshold and the temperature of the storage vessel is less than a threshold.

12. The storage combination boiler system of claim 1, wherein the storage vessel comprises a first tank and a second tank.

13. The storage combination boiler system of claim 1, further comprising a boiler housing arranged to enclose the dchp unit.

14. (canceled)

15. (canceled)

16. The storage combination boiler system of claim 1, wherein the storage vessel is physically separate from the from the heat exchanger.

17. A method for providing heating, using a domestic combined heat and power (dchp) unit that provides a heat output and an electricity output, the method comprising:
heating a fluid in a first piping system with the heat output of the dchp unit;
heating a fluid in a second piping system by transfer of heat from the fluid in the first piping system using a heat exchanger; and
receiving and storing fluid within the first piping system in a storage vessel located within that first piping system, downstream from the heat exchanger, so as to provide a thermal store for the heat in the first piping system.

18. The method of claim 17, wherein the first piping system comprises a first piping circuit and a second piping circuit, the method further comprising: controlling the flow of the fluid in the first piping system to flow either around the first piping circuit or around the second piping circuit; and wherein the storage vessel is located in the first piping circuit.

19. The method of claim 17, wherein the second piping circuit is a central heating piping network and the fluid in the first piping system is a central heating fluid.

20. (canceled)

21. The method of claim 17, further comprising:
controlling the dchp unit based on a temperature at the storage vessel.

22. The method of claim 21, wherein the step of controlling is based upon a comparison of the temperature of the storage vessel with a threshold temperature.

23. The method of claim 21, wherein the step of controlling is based upon a rate of change of the temperature of the storage vessel.

24. The method of claim 23, wherein the step of controlling is based on a comparison of rate of change of the temperature of the storage vessel with a threshold rate of change of temperature.

25. (canceled)
